(19) United States
(12) Patent Application Publication
(10) Pub. No.: US 2024/0220827 A1
(43) Pub. Date: Jul. 4, 2024

(54) Apparatus, Action Decision Method, and Computer System

(71) Applicant: Hitachi, Ltd., Tokyo (JP)

(72) Inventors: Tadayuki MATSUMURA, Tokyo (JP); Kanako Esaki, Tokyo (JP); Hiroyuki Mizuno, Tokyo (JP)

(21) Appl. No.: 18/540,035

(22) Filed: Dec. 14, 2023

(30) Foreign Application Priority Data
Dec. 28, 2022 (JP) 2022-212156

(51) Int. Cl. G06N 5/022

(52) U.S. Cl. CPC G06N 5/022

(57) ABSTRACT

A cooperative autonomous control is implemented in consideration of emotions of a person or another apparatus. An apparatus holds an internal model for predicting a future state of an environment, acquires observation data indicating a state of an environment observed by the apparatus, generates first state information using the observation data, generates second state information of an intelligent agent present around the apparatus based on the first state information, decides a self emotion of the apparatus based on the first state information, decides a self emotion of the intelligent agent based on the second state information, decides a social emotion based on self emotions of the apparatus and the intelligent agent, generates future first state information and future second state information using the internal model, and decides an action based on the future first state information, the future second state information, and the social emotion.

### CLAIM OF PRIORITY

The present application claims priority from Japanese patent application JP 2022-212156 filed on Dec. 28, 2022, the content of which is hereby incorporated by reference into this application.

### BACKGROUND OF THE INVENTION

### 1. Field of the Invention

The present invention relates to an action control technique for an apparatus that performs autonomous control.

### 2. Description of Related Art

The autonomous control technique is utilized in various types of industry such as transportation industry, manufacturing industry, and nursing industry. An apparatus in which the autonomous control technique is employed acts to achieve a predetermined purpose according to an environment.

Control in consideration of a mental state of a person present in an environment is required in a device that interacts with a person.

For example, Patent Literature 1 discloses a robot apparatus having a function of switching between an action selection criterion in consideration of its own state and an action selection criterion in consideration of a state of another person according to a situation.

### CITATION LIST

### Patent Literature

PTL 1: JP2005-199402A

### SUMMARY OF THE INVENTION

In the technique disclosed in Patent Literature 1, the action selection criteria are independent of each other. Therefore, cooperative autonomous control in consideration of the emotion of a person or another apparatus cannot be implemented.

An object of the invention is to implement cooperative autonomous control in consideration of the emotion of a person or another apparatus.

A representative example of the invention disclosed in the present application is as follows. That is, an apparatus that is present in a space, in which an intelligent agent that performs an action based on a mental state is present, and performs autonomous control includes: a processor; a storage device connected to the processor; and an interface connected to the processor. The apparatus holds an internal model for predicting a future state of an environment based on a state of an environment, a social emotion of an individual with respect to another individual, and an action. The apparatus executes action decision processing including: acquiring, via the interface, observation data indicating a state of an environment observed by the apparatus; generating, using the observation data, first state information including information related to the intelligent agent present around the apparatus, as a state of an environment grasped by the apparatus; generating, using the first state information, second state information including information related to the apparatus and another intelligent agent present around the intelligent agent, as a state of an environment grasped by the intelligent agent; deciding a self emotion of the apparatus based on the first state information; deciding a self emotion of the intelligent agent based on the second state information; deciding a social emotion of the apparatus with respect to the intelligent agent and a social emotion of the intelligent agent with respect to the apparatus or another intelligent agent based on the self emotion of the apparatus and the self emotion of the intelligent agent; generating, using the internal model, first prediction state information that is future prediction of the first state information and second prediction state information that is future prediction of the second state information; and deciding an action to be performed by the apparatus based on the first prediction state information, the second prediction state information, the social emotion of the apparatus with respect to the intelligent agent, and the social emotion of the intelligent agent with respect to the apparatus or another intelligent agent.

According to the invention, cooperative autonomous control in consideration of the emotion of a person or another device can be implemented. Problems, configurations, and effects other than those described above will be clarified by description of the following embodiments.

### BRIEF DESCRIPTION OF THE DRAWINGS

FIG. 1 is a diagram illustrating a hardware configuration of an autonomous apparatus according to a first embodiment;

FIG. 2 is a diagram illustrating an example of a space in which the autonomous apparatus according to the first embodiment is present;

FIG. 3 is a diagram illustrating an example of a functional configuration of the autonomous apparatus according to the first embodiment;

FIG. 4 is a diagram illustrating an example of an internal model held by the autonomous apparatus according to the first embodiment;

FIG. 5A is a diagram illustrating an example of an observation data database according to the first embodiment;

FIG. 5B is a diagram illustrating an example of an observation data database according to the first embodiment;

FIG. 6A is a diagram illustrating an example of an emotion data database according to the first embodiment;

FIG. 6B is a diagram illustrating an example of an emotion data database according to the first embodiment;

FIG. 7 is a flowchart illustrating an example of processing executed by the autonomous apparatus according to the first embodiment;

FIG. 8A is a diagram illustrating an example of an emotion determination rule held by the autonomous apparatus according to the first embodiment;

FIG. 8B is a diagram illustrating an example of an emotion determination rule held by the autonomous apparatus according to the first embodiment;

FIG. 9 is a diagram illustrating an example of a weight update rule held by the autonomous apparatus according to the first embodiment;

FIG. 10A is a diagram illustrating a display example of a processing result output by the autonomous apparatus according to the first embodiment;

FIG. 10B is a diagram illustrating a display example of a processing result output by the autonomous apparatus according to the first embodiment; and

FIG. 11 is a diagram illustrating an example of a functional configuration of an autonomous apparatus according to a second embodiment.

### DESCRIPTION OF EMBODIMENTS

Hereinafter, embodiments of the invention will be described with reference to the drawings. The invention is not to be construed as being limited to the description of the embodiments described below. It will be easily understood by those skilled in the art that the specific configuration can be changed without departing from the spirit or scope of the invention.

In the configurations of the invention described below, the same or similar configurations or functions are denoted by the same reference numerals, and a redundant description will be omitted.

Notations “first”, “second”, “third”, and the like in the present specification and the like are provided to identify components, and do not necessarily limit the number or the order.

In order to facilitate understanding of the invention, the position, size, shape, range, and the like of each configuration shown in the drawings and the like may not represent the actual position, size, shape, range, and the like. Accordingly, the invention is not limited to the positions, sizes, shapes, ranges, and the like disclosed in the drawings and the like.

### First Embodiment

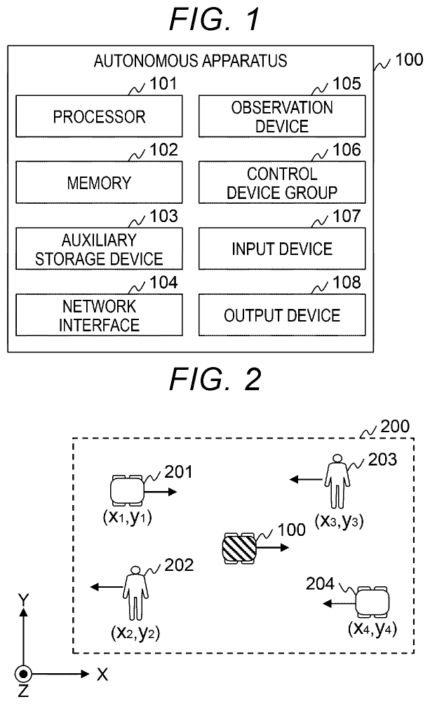

FIG. 1 is a diagram illustrating a hardware configuration of an autonomous apparatus according to a first embodiment. FIG. 2 is a diagram illustrating an example of a space in which the autonomous apparatus according to the first embodiment is present.

An autonomous apparatus 100 is a robot, an automobile, or the like, and performs an action based on an input obtained from an environment and emotions of a person and another autonomous apparatus present in the environment. For example, the autonomous apparatus 100 moves in a space 200 and performs conveyance of goods or the like. In the space 200, autonomous apparatuses 201 and 204 and persons 202 and 203 are present. The autonomous apparatus 100 acts in consideration of emotions of the autonomous apparatuses 201 and 204 and the persons 202 and 203.

In the present specification, an individual (a person or the autonomous apparatus 100) that acts based on a mental state is referred to as an intelligent agent. The intelligent agent recognized by the autonomous apparatus 100 is referred to as a recognized intelligent agent.

Emotions of an intelligent agent include a self emotion of an inner self and a social emotion that an intelligent agent (an individual having emotions) has for another intelligent agent. Examples of the self emotion include fear and joy. Examples of the social emotion include sympathy, trust, and hate.

The autonomous apparatus 100 includes a processor 101, a memory 102, an auxiliary storage device 103, a network interface 104, an observation device 105, a control device group 106, an input device 107, and an output device 108. The hardware configuration of the autonomous apparatus 100 is an example and the invention is not limited thereto. For example, the autonomous apparatus 100 may not include the input device 107 and the output device 108.

The processor 101 executes a program stored in the memory 102. The processor 101 executes processing according to a program, thereby operating as a functional unit (module) for implementing a specific function. In the following description, when processing is described with a functional unit as a subject, it is indicated that the processor 101 executes a program for implementing the functional unit.

The memory 102 stores a program executed by the processor 101 and information used by the program. The memory 102 is also used as a work area. The auxiliary storage device 103 is a large-capacity storage device and stores data permanently. The auxiliary storage device 103 is, for example, a hard disk drive (HDD) and a solid state drive (SSD). Programs and information stored in the memory 102 may be stored in the auxiliary storage device 103. In this case, the processor 101 reads the programs and the information from the auxiliary storage device 103 and loads the programs and the information into the memory 102.

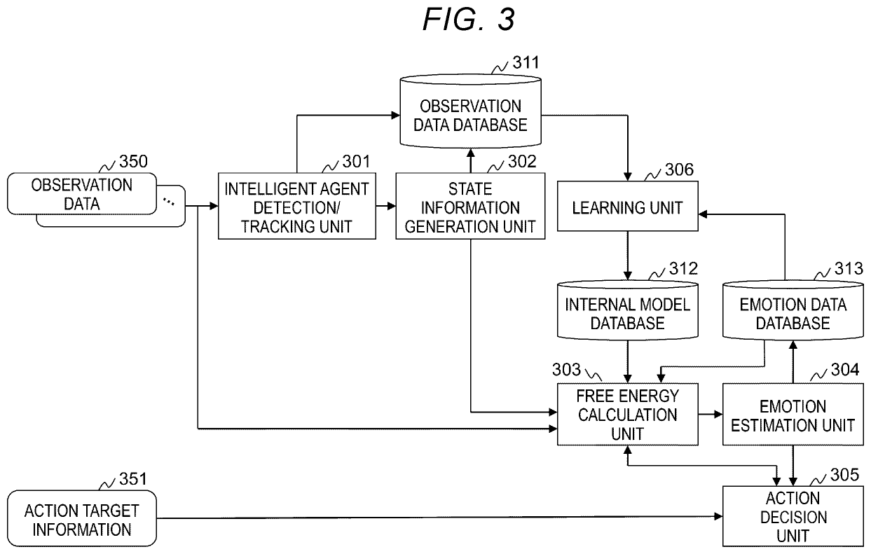

The network interface 104 communicates with an external device via a network. The observation device 105 is a camera, a LiDAR, a microphone, a millimeter-wave radar, an acceleration sensor, or the like, and acquires observation data 350 (see FIG. 3) including information for grasping a state of an environment.

The control device group 106 includes a motor, an utterance device, and the like. The input device 107 is a keyboard, a mouse, a touch panel, or the like, and receives an input from a user. The output device 108 is a display, a speaker, or the like, and outputs information to the user.

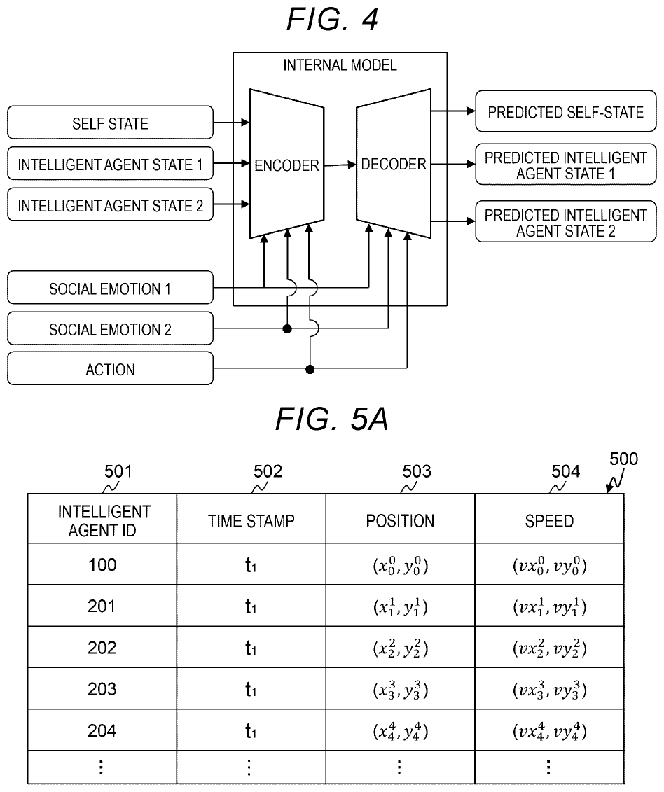

FIG. 3 is a diagram illustrating an example of a functional configuration of the autonomous apparatus 100 according to the first embodiment. FIG. 4 is a diagram illustrating an example of an internal model held by the autonomous apparatus 100 according to the first embodiment.

The autonomous apparatus 100 includes an intelligent agent detection/tracking unit 301, a state information generation unit 302, a free energy calculation unit 303, an emotion estimation unit 304, an action decision unit 305, and a learning unit 306. Further, the autonomous apparatus 100 includes an observation data database 311, an internal model database 312, and an emotion data database 313.

The autonomous apparatus 100 acquires the observation data 350 via the observation device 105. The observation data 350 is input to the intelligent agent detection/tracking unit 301 and the free energy calculation unit 303. The autonomous apparatus 100 receives action target information 351 via the network interface 104 or the input device 107.

The observation data 350 is, for example, an image and point cloud data. The action target information 351 is information for controlling selection of an action.

The observation data database 311 is a database for managing the observation data 350 and state information indicating a state of an environment. The internal model database 312 is a database for managing an internal model in a free energy principle. The emotion data database 313 is a database for managing a self emotion and a social emotion of an intelligent agent.

The intelligent agent detection/tracking unit 301 detects and tracks an intelligent agent present around the autonomous apparatus 100 by using the observation data 350. The intelligent agent detection/tracking unit 301 generates coordinates and a speed of the detected intelligent agent as self state information indicating a state of an environment grasped by the autonomous apparatus 100. The intelligent agent detection/tracking unit 301 stores the observation data 350 and the state information in the observation data database 311, and outputs the observation data 350 and a processing result to the state information generation unit 302.

The state information generation unit 302 generates, by using the observation data 350 and the state information, state information (other state information) indicating a state of an environment grasped by the recognized intelligent agent. For example, when coordinates and a speed are obtained as the state information, the other state information can be generated by performing coordinates conversion on the state information. When the observation data 350 is an image, an image (other observation data) acquired by the intelligent agent can be generated using an existing technique such as Novel View Synthesis, and other state information can be generated from the other observation data. The invention is not limited to an algorithm for generating other state information.

Hereinafter, the self state information and the other state information are referred to as state information when not distinguished from each other.

The free energy calculation unit 303 calculates free energy for deciding a self emotion and a social emotion of an intelligent agent (the autonomous apparatus 100 and the recognized intelligent agent). The free energy calculation unit 303 calculates expected free energy for deciding an action of the intelligent agent (the autonomous apparatus 100 and the recognized intelligent agent).

The free energy is defined by Equation (1) using a generative model P (s, o) of a latent state s of an environment and observation data o, an internal model Q_{θ} (s) determined by a parameter θ approximating a generative model of a latent variable s of the environment, and the observation data o. D_{KL} [ ] is a Kullback-Leibler distance, and E [ ] is an expected value.

$$F ( Q , o ) = - log P ( o ) + {D}_{KL} [ {Q}_{θ} ( s ) \vert \vert P ( s \vert o ) ] = {E}_{{Q}_{θ}} ( s ) [ log {Q}_{θ} ( s ) - log P ( s , o ) ] \qquad Equation ( 1 )$$

Here, an internal model according to the first embodiment will be described with reference to FIG. 4. FIG. 4 illustrates an example of an internal model in which an encoder and a decoder in a latent state are implemented by a neural network. The internal model receives a self state, an intelligent agent state, a social emotion, and an action, and outputs a predicted self state and a predicted intelligent agent state. The social emotion is input as binary data, a one-hot code, or a combination of a value obtained from free energy of a self intelligent agent and a value obtained from free energy of another intelligent agent. The self state is a state of the self intelligent agent included in the state information, and the intelligent agent state is a state of another intelligent agent included in the state information. The encoder adopts a probability sampling method (reparameterization trick) used in a variational auto-encoder (VAE), and probabilistically samples a latent state. That is, the internal model is a model that probabilistically outputs information on a future state based on information on a current state. Similarly to a β-VAE or the like, the internal model may have parameters for controlling learning.

The expected free energy is defined by Equation (2). π represents an action sequence, and tildes s and o are a latent state transition sequence and an observation data sequence when the action sequence π is executed. C is probability distribution representing a preference for observation data of an agent.

$$G ( π ) = - {E}_{Q ( \tilde{o} \vert π )} [ ln P ( \tilde{o} \vert C ) ] - {E}_{Q ( \tilde{S} , \tilde{O} \vert π )} [ {D}_{KL} [ Q ( \tilde{s} \vert \tilde{o} , π ) \vert \vert Q ( \tilde{s} \vert π ) ] ] \qquad Equation ( 2 )$$

In active inference, the expected free energy for each assumed action hypothesis is obtained, and probability distribution of an action is determined by, for example, the Softmax function of Equation (3) such that selection probability of the action hypothesis increases as the expected free energy decreases.

$$p ( π \vert {s}_{t} ) = \frac{{e}^{- γ G ( {s}_{t} , π )}}{{\sum }_{π ∈ A} {e}^{- γ G ( {s}_{t} , π )}} \qquad Equation ( 3 )$$

The free energy calculation unit 303 calculates free energy of the autonomous apparatus 100 using the self state information and the internal model. The free energy calculation unit 303 calculates free energy of an intelligent agent using the other state information and an internal model. The calculation of the free energy of the intelligent agent requires an internal model of the intelligent agent. In the first embodiment, the internal model of the intelligent agent is substituted with the internal model of the autonomous apparatus 100 on the basis of a simulation theory that a person sympathizes with another person by simulating a feeling of the other person using his/her body.

The free energy calculation unit 303 generates future self state information by inputting the self state information to the internal model, and calculates expected free energy of the autonomous apparatus 100 using the future self state information. The free energy calculation unit 303 generates future other state information by inputting the other state information to the internal model, and calculates expected free energy of the recognized intelligent agent using the future other state information.

The emotion estimation unit 304 estimates a self emotion of the autonomous apparatus 100, a social emotion of the autonomous apparatus 100 with respect to an intelligent agent, a self emotion of the intelligent agent, and a social emotion of the intelligent agent with respect to the autonomous apparatus 100 or another intelligent agent based on the free energy of the autonomous apparatus 100 and the recognized intelligent agent. An estimation method will be described later.

The action decision unit 305 decides an action to be performed by the autonomous apparatus 100, based on the expected free energy of the autonomous apparatus 100 and the recognized intelligent agent, the Equation (3), and the action target information 351. The learning unit 306 learns an internal model.

Regarding the functional units of the autonomous apparatus 100, a plurality of functional units may be integrated into one functional unit, or one functional unit may be divided into a plurality of functional units.

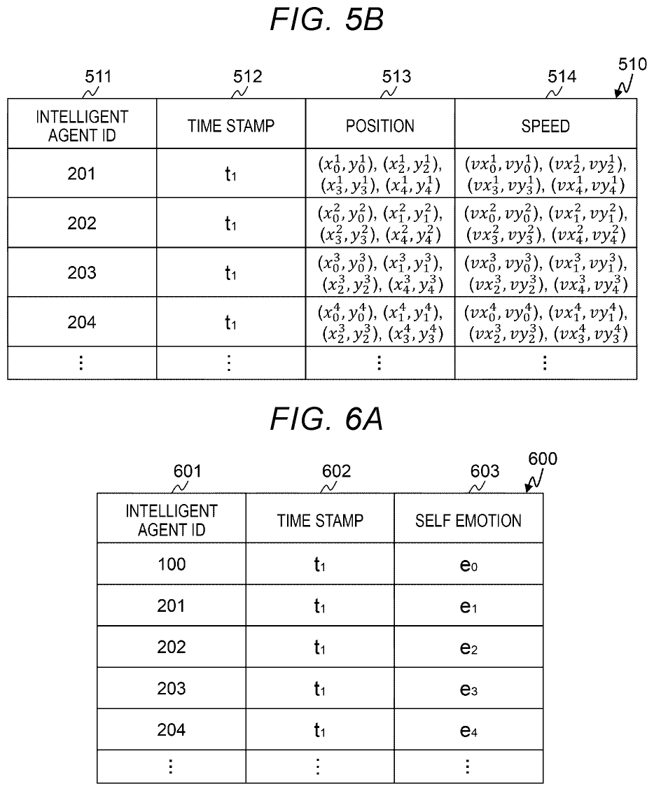

FIGS. 5A and 5B are diagrams illustrating examples of the observation data database 311 according to the first embodiment. The observation data database 311 stores a table 500 and a table 510.

The table 500 is a table storing the self state information generated by the intelligent agent detection/tracking unit 301. The table 500 includes entries including an intelligent agent ID 501, a time stamp 502, a position 503, and a speed 504. One entry exists for a combination of the intelligent agent and the time stamp. One entry indicates a state of an intelligent agent recognized by the autonomous apparatus 100 at a certain time-point.

The intelligent agent ID 501 is a field for storing identification information of a detected intelligent agent. The state of the autonomous apparatus 100 is also managed in the table 500. The time stamp 502 is a field for storing a time stamp included in the observation data 350. The position 503 and the speed 504 are a field group for storing a value that is calculated from the observation data 350 and that indicates a state grasped by the autonomous apparatus 100.

The table 510 stores other state information generated by the state information generation unit 302. The table 510 includes entries including an intelligent agent ID 511, a time stamp 512, a position 513, and a speed 514. One entry exists for a combination of the intelligent agent and the time stamp. One entry represents other state information of one recognized intelligent agent.

The intelligent agent ID 511 is a field for storing identification information of a detected intelligent agent. In the table 510, there is no entry of the autonomous apparatus 100. The time stamp 512 is a field for storing a time stamp. The time stamp 512 stores a time stamp of the observation data 350 of state information used to generate the other state information. The position 513 and the speed 514 are a field group for storing a value indicating a state grasped by a recognized intelligent agent.

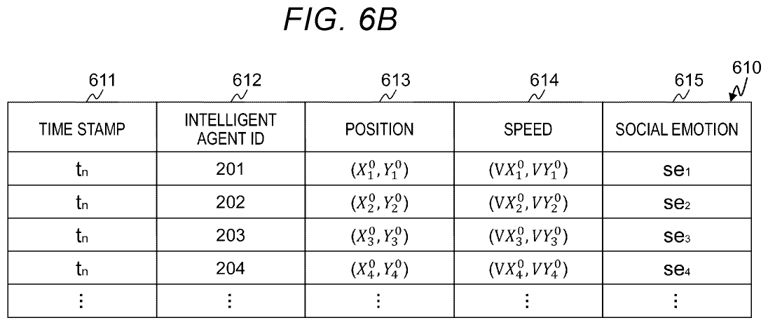

FIGS. 6A and 6B are diagrams illustrating examples of the emotion data database 313 according to the first embodiment. The emotion data database 313 stores a table 600 and a table 610.

The table 600 is a table for managing a self emotion. The table 600 includes entries including an intelligent agent ID 601, a time stamp 602, and a self emotion 603. One entry exists for a combination of the intelligent agent and the time stamp.

The intelligent agent ID 601 is a field for storing identification information of an intelligent agent. The time stamp 602 is a field for storing a time stamp of state information used for calculating the self emotion. The self emotion 603 is a field for storing the self emotion of the intelligent agent.

The table 610 is a table for managing a social emotion. A table 610 exists for each intelligent agent. The table 610 shown in FIG. 6 is a table for managing a social emotion of the autonomous apparatus 100 with respect to a recognized intelligent agent.

The table 610 includes entries including a time stamp 611, an intelligent agent ID 612, a position 613, a speed 614, and a social emotion 615. One entry exists for a combination of the intelligent agent and the time stamp.

The time stamp 611 is a field for storing a time stamp of state information used for calculating expected free energy. When a plurality of pieces of observation data 350 are input as time-series data, a time stamp of the first or last observation data 350 of the time-series data is stored in the time stamp 611. The intelligent agent ID 612 is a field for storing identification information of an intelligent agent. The position 613 and the speed 614 are a field group for storing a prediction state information calculated using an internal model. The social emotion 615 is a field for storing a social emotion of an intelligent agent with respect to another intelligent agent.

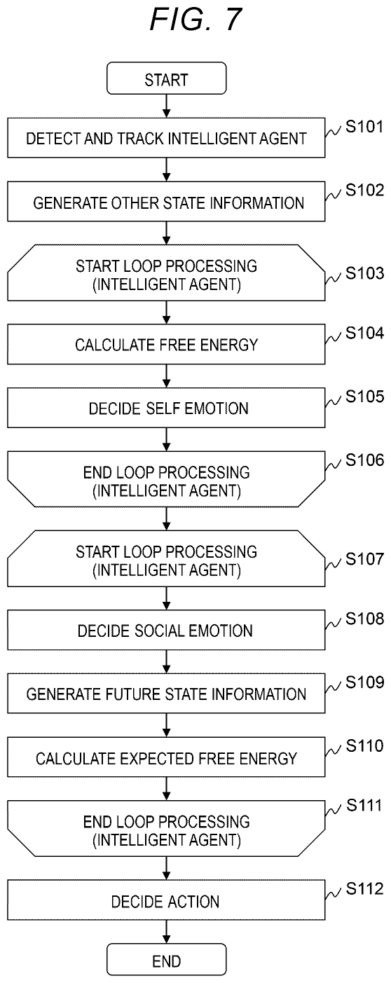

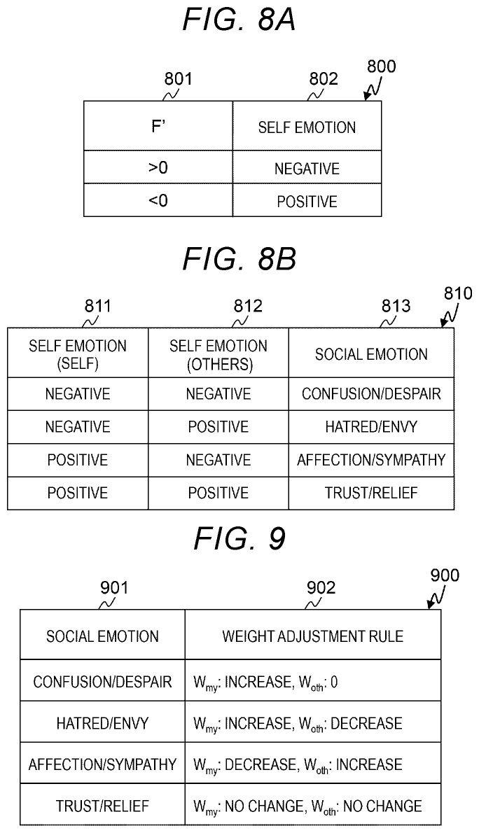

FIG. 7 is a flowchart illustrating an example of processing executed by the autonomous apparatus 100 according to the first embodiment. FIGS. 8A and 8B are diagrams illustrating examples of emotion determination rules held by the autonomous apparatus 100 according to the first embodiment. FIG. 9 is a diagram illustrating an example of a weight update rule held by the autonomous apparatus 100 according to the first embodiment.

The autonomous apparatus 100 uses the received observation data 350 to execute processing described below. An execution timing can be set freely. For example, the processing may be executed when the observation data 350 is received or when a predetermined number of pieces of observation data 350 are accumulated.

The intelligent agent detection/tracking unit 301 performs detection and tracking of an intelligent agent using the observation data 350 (step S101).

The state information generation unit 302 generates other state information of a recognized intelligent agent using the observation data 350 (step S102).

The free energy calculation unit 303 starts loop processing of the intelligent agent (step S103). Specifically, the free energy calculation unit 303 selects one intelligent agent from the autonomous apparatus 100 and the recognized intelligent agent.

The free energy calculation unit 303 calculates free energy using state information of the intelligent agent (step S104).

The emotion estimation unit 304 decides a self emotion based on the free energy (step S105).

Here, the emotion determination rule managed by the autonomous apparatus 100 will be described. The autonomous apparatus 100 holds tables 800 and 810 as emotion determination rules.

The table 800 is a table for managing emotion determination rules for deciding a self emotion. The table 800 stores entries including an F′ 801 and a self emotion 802.

The F′ 801 is a field for storing a condition related to a value of first-order differentiation of free energy. The self emotion 802 is a field for storing a value indicating a self emotion. In the embodiment, when the value of the first-order differentiation of the free energy is positive, the self emotion is determined to be negative, and when the value of the first-order differentiation of the free energy is negative, the self emotion is determined to be positive.

The determination rule shown in the table 800 is an example and the invention is not limited thereto. For example, the self emotion may be defined with respect to a combination of a condition related to the value of the first-order differentiation of the free energy and a condition related to a value of second-order differentiation of the free energy. Accordingly, it is possible to set various self emotions.

The table 810 is a table for managing emotion determination rules for deciding a social emotion. The table 810 stores entries including a self emotion (self) 811, a self emotion (others) 812, and a social emotion 813.

The self emotion (self) 811 is a field for storing a self emotion of a self intelligent agent. The self emotion (others) 812 is a field for storing a self emotion of another intelligent agent. The social emotion 813 is a field for storing a value indicating a social emotion.

The emotion estimation unit 304 decides the self emotion of the intelligent agent using the free energy of the intelligent agent and the table 800.

The free energy calculation unit 303 determines whether the processing is completed for all the intelligent agents (step S106).

When the processing is not completed for all the intelligent agents, the free energy calculation unit 303 returns to step S103 and selects a new intelligent agent.

When the processing is completed for all the intelligent agents, the emotion estimation unit 304 starts the loop processing of the intelligent agents (step S107). Specifically, the emotion estimation unit 304 selects one intelligent agent from the autonomous apparatus 100 and the recognized intelligent agent. The selected intelligent agent is referred to as a target intelligent agent.

The emotion estimation unit 304 decides a social emotion of the target intelligent agent with respect to another intelligent agent (step S108). Specifically, the following processing is executed.

(S108-1) The emotion estimation unit 304 selects one intelligent agent from the intelligent agents excluding the target intelligent agent. The selected intelligent agent is referred to as a sub-target intelligent agent.

(S108-2) The emotion estimation unit 304 decides a social emotion of the target intelligent agent with respect to the sub-target intelligent agent based on a self emotion of the target intelligent agent, a self emotion of the sub-target intelligent agent, and the table 810.

(S108-3) The emotion estimation unit 304 determines whether the processing is completed for all the intelligent agents excluding the target intelligent agent. When the processing is not completed for all the intelligent agents excluding the target intelligent agent, the emotion estimation unit 304 returns to S108-1 and selects a new sub-target intelligent agent. When the processing is completed for all the intelligent agents excluding the target intelligent agent, the emotion estimation unit 304 ends the processing of step S108.

The free energy calculation unit 303 generates future state information of the intelligent agent (step S109).

Specifically, the free energy calculation unit 303 acquires the latest social emotion from the table 610 of the intelligent agent stored in the emotion data database 313. The free energy calculation unit 303 acquires an action of the intelligent agent from the action decision unit 305 that is a hypothesis. The free energy calculation unit 303 calculates future state information by inputting the state information, the social emotion, and the action of the intelligent agent to an internal model.

The free energy calculation unit 303 calculates, by using the future state information, expected free energy of the intelligent agent with respect to the action that is a hypothesis (step S110).

The emotion estimation unit 304 determines whether the processing is completed for all the intelligent agents (step S111).

When the processing is not completed for all the intelligent agents, the emotion estimation unit 304 returns to step S107 and selects a new intelligent agent.

When the processing is completed for all the intelligent agents, the action decision unit 305 decides an action of the autonomous apparatus 100 based on the expected free energy and the social emotion (step S112).

The action decision unit 305 according to the first embodiment decides an action a based on integrated expected free energy expressed by Equation (4) and the action target information 351. Here, an index i represents a recognized intelligent agent. G_{my} is the expected free energy of the autonomous apparatus 100, and Gₒₜₕⁱ is the expected free energy of the recognized intelligent agent. W_{my} and Wₒₜₕⁱ are weights.

$$G ( {a}_{t} ) = {W}_{my} \cdot {G}_{my} + {\sum }_{i} {W}_{oth}^{i} \cdot {G}_{oth}^{i} \qquad Equation ( 4 )$$

The action decision unit 305 adjusts a weight according to the social emotion. For example, the weight is adjusted based on a table 900 as illustrated in FIG. 9. The table 900 includes entries including a social emotion 901 and a weight adjustment rule 902. The social emotion 901 is a field for storing a social emotion. The weight adjustment rule 902 is a field for storing a weight adjustment rule. It is assumed that a change amount of the weight is set in advance.

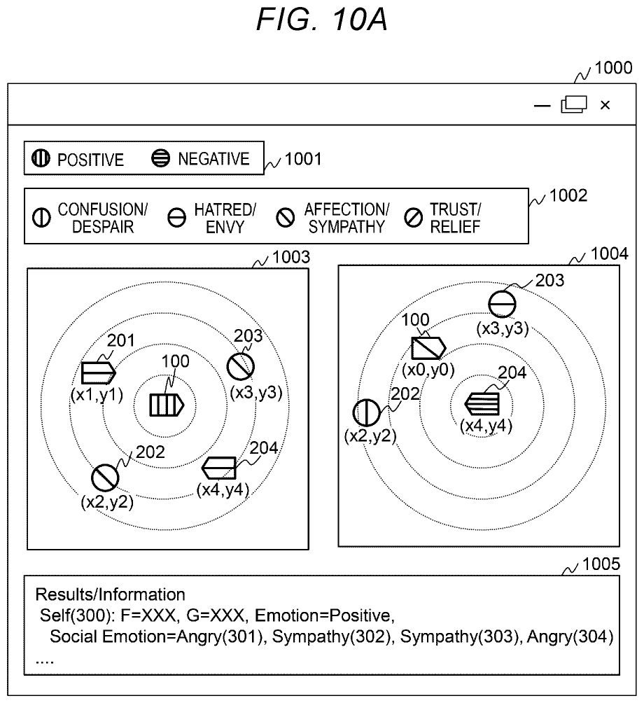

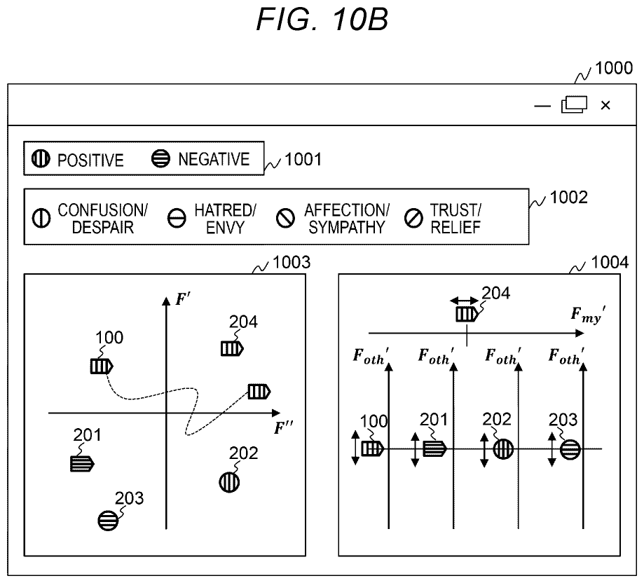

The autonomous apparatus 100 can output a result of the processing described in FIG. 7 to the outside. FIGS. 10A and 10B are diagrams illustrating display examples of processing results output by the autonomous apparatus 100 according to the first embodiment.

A screen 1000 illustrated in FIG. 10A includes icon description fields 1001 and 1002 and display fields 1003, 1004, and 1005.

The icon description fields 1001 and 1002 are fields for displaying descriptions of icons indicating a self emotion and a social emotion.

The display field 1003 is a field for displaying results of various types of processing based on the autonomous apparatus 100. The display field 1003 displays a self emotion of the autonomous apparatus 100, a social emotion of the autonomous apparatus 100 with respect to a recognized intelligent agent, prediction results of actions of the autonomous apparatus 100 and the recognized intelligent agent, and the like. The display field 1004 is a field for displaying results of various types of processing based on a recognized intelligent agent designated by a user. The display field 1005 is a field for displaying a text indicating the processing result.

The free energy, predicted observation data, the weight, and the like may be displayed in the display fields 1003 and 1004.

In addition, as illustrated in FIG. 10B, information related to the free energy used to decide the emotion may be displayed on the screen 1000. For example, the display field 1003 displays a graph showing a value of first-order differentiation and a value of second-order differentiation of the free energy of each intelligent agent. The display field 1004 displays a graph in which a horizontal axis represents a value of first-order differentiation of the free energy of a specified intelligent agent and a vertical axis represents a value of first-order differentiation of the free energy of another intelligent agent.

The learning unit 306 executes learning processing of an internal model by using the state information, the social emotion, and the like. When the internal model is implemented by an encoder and a decoder based on a neural network, a social emotion as a condition is input to the encoder and the decoder, and the learning processing is executed. When the internal model has a parameter for controlling learning similarly to a β-VAE or the like, a parameter for controlling learning is set based on the social emotion.

According to the first embodiment, the autonomous apparatus 100 can control an action based on a self emotion and a social emotion with respect to a recognized intelligent agent. That is, cooperative autonomous control in consideration of the emotion of a person or another apparatus can be implemented.

(Modification) A computer system that centrally manages the autonomous apparatus 100 may hold the functional configuration as illustrated in FIG. 3, acquire the observation data 350 from the autonomous apparatus 100, and perform calculation of free energy, estimation of an emotion, and decision of an action.

### Second Embodiment

The second embodiment is different in that the autonomous apparatus 100 exchanges information with another autonomous apparatus via communication. Hereinafter, the second embodiment will be described focusing on differences from the first embodiment.

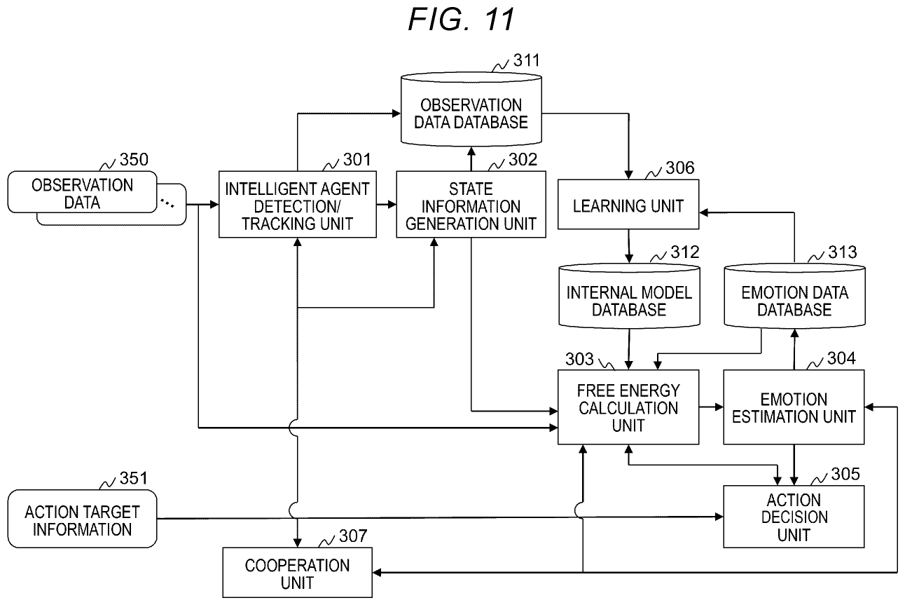

A hardware configuration of the autonomous apparatus 100 according to the second embodiment is the same as that in the first embodiment. A functional configuration of the autonomous apparatus 100 according to the second embodiment is partially different from that in the first embodiment. FIG. 11 is a diagram illustrating an example of the functional configuration of the autonomous apparatus 100 according to the second embodiment.

The autonomous apparatus 100 according to the second embodiment includes a new cooperation unit 307. Other functional configurations are the same as those in the first embodiment. The cooperation unit 307 exchanges information between the autonomous apparatuses 100. The cooperation unit 307 is connected to the intelligent agent detection/tracking unit 301, the state information generation unit 302, the free energy calculation unit 303, and the emotion estimation unit 304, and outputs information according to a type of information received from another autonomous apparatus 100. In addition, the cooperation unit 307 acquires information from any one of the intelligent agent detection/tracking unit 301, the state information generation unit 302, the free energy calculation unit 303, and the emotion estimation unit 304, and transmits the information to another autonomous apparatus 100.

A data structure of each database held by the autonomous apparatus 100 according to the second embodiment is the same as that in the first embodiment.

Processing executed by the autonomous apparatus 100 according to the second embodiment is the same as that in the first embodiment. However, when there is information received from another autonomous apparatus 100 in each processing step, the information is used.

By exchanging information between the autonomous apparatuses 100, it is possible to grasp an intelligent agent that is not detected due to shielding in a certain autonomous apparatus 100. In addition, an effect of reducing a calculation amount of the autonomous apparatus 100 is also expected. Further, more cooperative control can be implemented between the autonomous apparatuses 100.

The invention is not limited to the above-described embodiments, and includes various modifications. For example, the configurations in the above-described embodiments have been described in detail to facilitate understanding of the invention, and the invention is not necessarily limited to those including all the configurations described above. A part of a configuration in each embodiment may be added, deleted, or replaced with another configuration.

Some or all of the above configurations, functions, processing units, processing methods, and the like may be implemented by hardware by, for example, designing with an integrated circuit. The invention can also be implemented by a program code of software for implementing the functions in the embodiments. In this case, a storage medium storing the program code is provided to a computer, and a processor provided in the computer reads the program code stored in the storage medium. In this case, the program code itself read from the storage medium implements the functions of the above-described embodiments, and the program code itself and the storage medium storing the program code constitute the invention. As the storage medium for supplying such a program code, for example, a flexible disk, a CD-ROM, a DVD-ROM, a hard disk, a solid state drive (SSD), an optical disk, a magneto-optical disk, a CD-R, a magnetic tape, a nonvolatile memory card, or a ROM is used.

Further, the program code for implementing the functions described in the embodiment can be implemented in a wide range of programs or script languages such as assembler, C/C++, perl, Shell, PHP, Python, and Java (registered trademark).

Further, the program code of software for implementing the functions of the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are illustrated in the embodiments described above, and not all control lines and information lines in a product are necessarily illustrated. All the configurations may be connected to one another.

What is claimed is:

1. An apparatus that is present in a space, in which an intelligent agent that performs an action based on a mental state is present, and performs autonomous control, the apparatus comprising:
a processor;
a storage device connected to the processor; and
an interface connected to the processor, wherein
the apparatus holds an internal model for predicting a future state of an environment based on a state of the environment, a social emotion of an individual with respect to another individual, and an action, and
the apparatus executes action decision processing including:
acquiring, via the interface, observation data indicating a state of an environment observed by the apparatus;
generating, using the observation data, first state information including information related to the intelligent agent present around the apparatus, as a state of an environment grasped by the apparatus;
generating, using the first state information, second state information including information related to the apparatus and another intelligent agent present around the intelligent agent, as a state of an environment grasped by the intelligent agent;
deciding a self emotion of the apparatus based on the first state information;
deciding a self emotion of the intelligent agent based on the second state information;
deciding a social emotion of the apparatus with respect to the intelligent agent and a social emotion of the intelligent agent with respect to the apparatus or another intelligent agent based on the self emotion of the apparatus and the self emotion of the intelligent agent;
generating, using the internal model, first prediction state information that is future prediction of the first state information and second prediction state information that is future prediction of the second state information; and
deciding an action to be performed by the apparatus based on the first prediction state information, the second prediction state information, the social emotion of the apparatus with respect to the intelligent agent, and the social emotion of the intelligent agent with respect to the apparatus or another intelligent agent.

2. The apparatus according to claim 1, wherein
the apparatus
calculates free energy in a free energy principle of the apparatus using the first state information and decides a self emotion of the apparatus based on the free energy of the apparatus,
calculates the free energy of the intelligent agent using the second state information and decides a self emotion of the intelligent agent based on the free energy of the intelligent agent, and
decides a social emotion of the apparatus with respect to the intelligent agent and a social emotion of the intelligent agent with respect to the apparatus or another intelligent agent based on a combination of the self emotion of the apparatus and the self emotion of the intelligent agent.

3. The apparatus according to claim 2, wherein
the apparatus
calculates expected free energy in the free energy principle of the apparatus using the first prediction state information,
calculates the expected free energy of the intelligent agent using the second prediction state information, and
decides an action of the apparatus based on a weighted sum of the expected free energy of the apparatus and the expected free energy of the intelligent agent, and
a weight to be multiplied by each of the expected free energy of the apparatus and the expected free energy of the intelligent agent is decided based on a social emotion of the apparatus with respect to the intelligent agent and a social emotion of the intelligent agent with respect to the apparatus or another intelligent agent.

4. The apparatus according to claim 1, wherein
the intelligent agent includes another device that executes the action decision processing,
the apparatus acquires a calculation result calculated in the action decision processing from the other device, and
the action decision processing is executed using the first state information and the acquired calculation result.

5. The apparatus according to claim 1, wherein
the apparatus executes learning processing of learning the internal model, and
a social emotion of the apparatus with respect to the intelligent agent and a social emotion of the intelligent agent with respect to the apparatus or another intelligent agent are used in the learning processing.

6. An action decision method to be executed by an apparatus that is present in a space, in which an intelligent agent that performs an action based on a mental state is present, and performs autonomous control,
the apparatus including a processor, a storage device connected to the processor, and an interface connected to the processor, and holding an internal model for predicting a future state of an environment based on a state of the environment, a social emotion of an individual with respect to another individual, and an action,
the action decision method comprising:
a first step of the processor acquiring, via the interface, observation data indicating a state of an environment observed by the apparatus;
a second step of the processor generating, using the observation data, first state information including information related to the intelligent agent present around the apparatus, as a state of an environment grasped by the apparatus;
a third step of the processor generating, using the first state information, second state information including information related to the apparatus and another intelligent agent present around the intelligent agent, as a state of an environment grasped by the intelligent agent;
a fourth step of the processor deciding a self emotion of the apparatus based on the first state information;
a fifth step of the processor deciding a self emotion of the intelligent agent based on the second state information;
a sixth step of the processor deciding a social emotion of the apparatus with respect to the intelligent agent and a social emotion of the intelligent agent with respect to the apparatus or another intelligent agent based on the self emotion of the apparatus and the self emotion of the intelligent agent;
a seventh step of the processor generating, using the internal model, first prediction state information that is future prediction of the first state information and second prediction state information that is future prediction of the second state information; and
an eighth step of the processor deciding an action to be performed by the apparatus based on the first prediction state information, the second prediction state information, the social emotion of the apparatus with respect to the intelligent agent, and the social emotion of the intelligent agent with respect to the apparatus or another intelligent agent.

7. The action decision method according to claim 6, wherein
the fourth step includes
a step of the processor calculating free energy in a free energy principle of the apparatus using the first state information, and
a step of the processor deciding a self emotion of the apparatus based on the free energy of the apparatus,
the fifth step includes
a step of the processor calculating the free energy of the intelligent agent using the second state information, and
a step of the processor deciding a self emotion of the intelligent agent based on the free energy of the intelligent agent, and
in the sixth step, a social emotion of the apparatus with respect to the intelligent agent and a social emotion of the intelligent agent with respect to the apparatus or another intelligent agent are decided based on a combination of the self emotion of the apparatus and the self emotion of the intelligent agent.

8. The action decision method according to claim 7, wherein
the eighth step includes
a step of the processor calculating expected free energy in the free energy principle of the apparatus using the first prediction state information,
a step of the processor calculating the expected free energy of the intelligent agent using the second prediction state information, and
a step of the processor deciding an action of the apparatus based on a weighted sum of the expected free energy of the apparatus and the expected free energy of the intelligent agent, and
a weight to be multiplied by each of the expected free energy of the apparatus and the expected free energy of the intelligent agent is decided based on a social emotion of the apparatus with respect to the intelligent agent and a social emotion of the intelligent agent with respect to the apparatus or another intelligent agent.

9. A computer system to be connected to an apparatus that is present in a space, in which an intelligent agent that performs an action based on a mental state is present, and performs autonomous control, wherein
the computer system
holds an internal model for predicting a future state of an environment based on a state of the environment, a social emotion of an individual with respect to another individual, and an action,
acquires observation data indicating a state of an environment observed by the apparatus,
generates, using the observation data, first state information including information related to the intelligent agent present around the apparatus, as a state of an environment grasped by the apparatus,
generates, using the first state information, second state information including information related to the apparatus and another intelligent agent present around the intelligent agent, as a state of an environment grasped by the intelligent agent,
decides a self emotion of the apparatus based on the first state information,
decides a self emotion of the intelligent agent based on the second state information,
decides a social emotion of the apparatus with respect to the intelligent agent and a social emotion of the intelligent agent with respect to the apparatus or another intelligent agent based on the self emotion of the apparatus and the self emotion of the intelligent agent,
generates, using the internal model, first prediction state information that is future prediction of the first state information and second prediction state information that is future prediction of the second state information, and
decides an action to be performed by the apparatus based on the first prediction state information, the second prediction state information, the social emotion of the apparatus with respect to the intelligent agent, and the social emotion of the intelligent agent with respect to the apparatus or another intelligent agent.
